(19) United States
(12) Patent Application Publication
(10) Pub. No.: US 2007/0133360 A1
(43) Pub. Date: Jun. 14, 2007

(54) DATA SEARCH SYSTEM FOR SEARCHING A DATA SYNC PATTERN STORED IN AN OPTICAL DISC BY A PHYSICAL ADDRESS

(75) Inventors: Yu-hsuan Lin, Taichung City (TW); Jin-bin Yang, Sihu Township (TW); Ching-ning Chiu, Chu-Pei City (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: MediaTek Inc., Hsin-Chu City (TW)

(21) Appl. No.: 11/421,544

(22) Filed: Jun. 1, 2006

Related U.S. Application Data
(60) Provisional application No. 60/748,559, filed on Dec. 8, 2005.

(51) Int. Cl. G11B 7/085

(52) U.S. Cl. 369/30.03

(57) ABSTRACT

A data search system for searching a data sync pattern stored in an optical disc by using a physical address is disclosed. The data search system comprises a physical address decoder, a data start indicator and a data sync pattern search circuit. The physical address decoder decodes a physical address signal read from the optical disc to obtain the physical address of a current position. The data start indicator generates a start search signal when the pickup head indicates a predetermined physical address to decide a start position. The data sync pattern search circuit searches the data sync pattern of the data from the start position to determine a cluster area of the data following the data sync pattern. The data search system further comprises a window generator, generating a window interval starting from the start position to search the data sync pattern therein.

### CROSS REFERENCE TO RELATED APPLICATION

This application claims the benefit of U.S. Provisional Patent Application Ser. No. 60/748,559, filed Dec. 8, 2005.

### FIELD OF THE INVENTION

The present invention generally relates to a data search system for searching a data sync pattern, and more particularly to a data search system for searching a data sync pattern stored in an optical disc by a physical address.

### BACKGROUND OF THE INVENTION

According to the standard of Blu-Ray optical discs, the unit of recording data stored in an optical disc is a Recording Unit Block (RUB). It basically includes a Run-in area, a cluster area, a Run-out area, and a Guard_3 area in sequent order. The Run-in and Run-out areas are specific blocks allowing the optical disc drive to synchronize data. The cluster area is for recording the user data. The Guard_3 area is employed to prevent unrecorded area occurring between two RUBs in a consecutively recorded data (“consecutive” means no existing blank area; “non-consecutive” means a blank area exists). Moreover, a data sync pattern exists in the head of the cluster area and after the Run-in area. The data sync pattern is a specific data pattern in the head of a cluster area for the optical disc drive to start the decoding of reading, searching the cluster area data or information stored in an optical disc. The HD-DVD specifications share similar definitions for the physical structures as Blu-ray Disc. A VFO field is similar to the Run-in area; a data field is similar to the cluster area; a buffer is similar to the Run-out area; a Guard field is similar to the Guard_3 area, respectively. Similarly, the data sync pattern, a specific data pattern also in the head of the data field for the optical disc drive to start the decoding of reading, searching the data or information in the HD-DVD specifications.

Previously, the optical disc drive can obtain the current position indicated by a pickup head from the RUBs such as CD, DVD (and is still a currently used method), but the content of the RUBs may be variable and sometimes even unpredictable track defects of the optical disc will influence the decoding result from the user data. Therefore, the data sync pattern search method according to the prior art, always searches the data sync pattern in the RUBs from the very beginning of the tracks will result to a high fail rate in the search for the data sync pattern.

Furthermore, discs such as CD, DVD or other discs are developed in earlier time, and if a user is going to write (record) data into the optical disc, the only way of writing data is from the very beginning of the Land or Groove tracks in the optical disc in consecutive manner. The intermittent recording or the recording at arbitrary sectors of the Land or Groove tracks in the optical disc will never be allowed. Therefore, searching the data sync pattern to determine the cluster area of the data is also performed from the very beginning as a default setting according to prior arts and is to prevent a mis-recognizing the data sync pattern. However, as the AV (audio and video) optical storage media technology progresses to rewritable digital versatile disc in the present day, the mode of recording data is more arbitrary as according to users' demand. Therefore, optical disc intermittent recording or recording at arbitrary sector of the Land or Groove tracks is now available as one option in Blu-Ray or HD-DVD disc. For example, a user can record one minute of music (or any other digital data) by starting from the track near the periphery of the optical disc; there's no need to start recording data from the very beginning of the tracks. Further, when an optical disc has defects on specified tracks, it will be a great benefit for the user to write the data into the good tracks of the optical disc as desired.

However, such intermittent recording or recording at arbitrary tracks in the optical disc may cause problems of failing to search data sync pattern, thereby resulting in mis-decoding the cluster area of the data and causing an unstable status of the whole optical disc drive. In a non-consecutively recorded data, a blank area exists prior to the Run-in area and the cluster area of the data, but the data sync pattern searching method according to the prior arts always searches the data sync pattern in the RUBs from the very beginning of the tracks. However, the data sync pattern searching method according to the prior arts can not recognize the blank area well; meanwhile, searching from the very beginning of the tracks may increase the mis-recognizing rate if the data of intermittent recording or recording at arbitrary tracks share some pattern similarity to the data sync pattern. The similar pattern to the data sync pattern existing in the tracks may be mis-recognized by the optical disc drive and causes the optical disc drive to fail in searching the data sync pattern. This mis-decoding occurrence, thereby, causing the optical disc drive to get trapped in a dead loop as the data sync pattern is never to be located in this manner.

### SUMMARY OF THE INVENTION

To solve the foregoing drawbacks in the prior art, it is an objective of the present invention to provide a data search system for searching a data sync pattern stored in an optical disc by a physical address and in a non-consecutively recorded data with a low failure rate; even in a consecutively recorded data becomes more quickly and correctly.

To accomplish the above objective, the present invention provides a data search system for searching a data sync pattern stored in an optical disc by using a physical address. The data search system comprises a physical address decoder, a data start indicator and a data sync pattern search circuit. The physical address decoder decodes a physical address signal read from the optical disc to obtain the physical address of a current position indicated by a pickup head. The data start indicator generates a start search signal when the pickup head indicates a predetermined physical address to decide a start position. The data sync pattern search circuit searches the data sync pattern of the data from the start position to determine a cluster area of the data following the data sync pattern. The data search system further comprises a window generator. The window generator receives the start search signal to generate a window interval starting from the start position for the data sync pattern search circuit to search the data sync pattern therein. The predetermined physical address can be a beginning position of the reference block or a beginning position of the first data block in physical address content of an optical disc. The data start indicator further receives a position shifting signal from the optical disc drive for adjusting the start position. The window generator further receives a window sizing signal from the optical disc drive for adjusting a size of the window interval for searching the data sync pattern of the data.

With the determination of the cluster area, the data search system further comprises a data demodulating and processing circuit. The data demodulating and processing circuit starts to demodulate and process the cluster area to obtain demodulated data according to a sync signal from the data sync pattern search circuit. Moreover, the data search system comprises a data decoder for decoding the demodulated data.

The present invention provides a method of searching a data sync pattern stored in an optical disc to accomplish the above object.

The method comprises the steps of:

decoding a physical address signal read from the optical disc to obtain a physical address of a current position indicated by a pickup head;

generating a start search signal when the pickup head indicates a predetermined physical address to decide a start position; and

searching the data sync pattern of the data from the start position to determine a cluster area of the data following the data sync pattern.

The method of searching the data sync pattern further comprises a step of generating a window interval starting from the start position for the data sync pattern search circuit to search the data sync pattern therein.

The method of searching the data sync pattern further comprises a step of adjusting the start position according to the position shifting signal before the step of generating the start search signal, and a step of adjusting the size of the window interval before the step of generating a window interval.

With reference to the physical address, the adjustable window interval, and the adjustable start search position for the window interval, accordingly, a data search system for searching the data sync pattern by a physical address according to the present invention can be realized to obtain a low failure rate of searching the data sync pattern for a non-consecutively recorded data, and even searching a consecutively recorded data more quickly and correctly.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is an illustration showing the physical address content corresponding to current and preceding clusters of a consecutively recorded data in a Blu-Ray R/RW optical disc.

FIG. 1B is an illustration showing the physical address content corresponding to a current cluster and a blank of a non-consecutively recorded data in a Blu-Ray R/RW optical disc.

FIG. 2 is an illustration showing the physical segment content corresponding to a VFO field, a data sync pattern in the head of the data field, the data field, a buffer and a Guard field of a consecutively recorded data in a HD-DVD specification optical disc.

FIG. 3 illustrates a functional block diagram of a data search system for searching the data sync pattern by using a physical address according to the first embodiment of the present invention.

FIG. 4 illustrates a functional block diagram of a data search system further comprising a data demodulating and processing circuit and data decoder according to the second embodiment of the present invention.

FIG. 5 shows a flow chart of the searching method of a data sync pattern stored in an optical disc according to the first embodiment of the present invention.

### DETAILED DESCRIPTION OF THE PREFERRED EMBODIMENTS

First, a physical address existing in the optical disc can solve the aforementioned problems. As generally known, the track of the optical disc is in a spiral construction. Strictly speaking, the track is not simply spiraling but vibrating in a sin wave along with the spiral track. The feature of the tracks vibrating in a sin wave is referred to as “wobble”, which already exists in the optical disc. The information obtained from an optical disc is not only the data but also the physical addresses (wobble address). Therefore, a data search system for searching the data sync pattern by a physical address according to the present invention is proposed to solve the problems of data sync pattern search failure for a non-consecutively recorded data or even a consecutively recorded data.

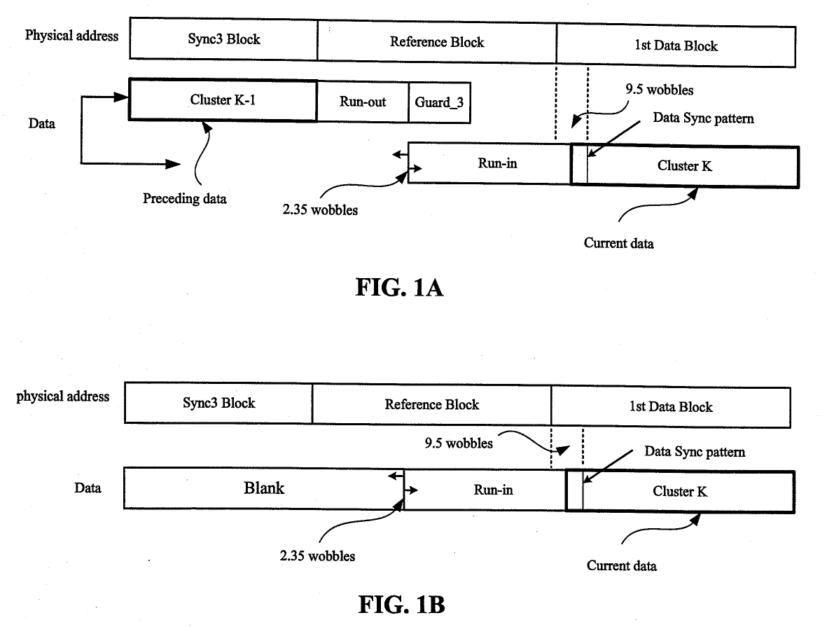

Please refer to FIG. 1A, an illustration showing the physical address content corresponding to current and preceding clusters of a consecutively recorded data in a Blu-Ray R/RW optical disc. The upper block line and the lower block line represent the physical address content and the data content respectively. The upper block line comprises a Sync3 block, a reference block, and a 1st data block. The lower block line comprises, a Run-in area, a Run-out area, a Guard_3 area, a cluster K-1 area (preceding cluster), a data sync pattern in the head of a cluster K area and the cluster K area (current cluster) of the data consecutively recorded in a Blu-Ray R/RW optical disc. The Sync3 block, reference block, 1st data block, cluster K-1 area, Run-out area, a Guard_3 area, Run-in area, data sync pattern, and the cluster K area are all defined according to the specification of Blu-Ray R/RW optical disc. The cluster K-1 area and the cluster K area are the areas for recording the user data. Each RUB (Recording Unit Block), includes a Run-in area, a cluster area, a Run-out area, and a Guard_3 area.

Specifically, the start position of the Run-in area is allowed to be shifted left or right 2.35 wobbles and the start position of the cluster K area in the RUB (Recording Unit Block) should be in the range within 9.5 wobbles after the end of the reference block or the beginning of the first data block of the physical address according to the specification of the Blu-Ray R/RW optical disc. When a user attempts to obtain the user data recorded in the cluster K area by an optical disc drive, in order to determine the cluster K area of the data, a data sync pattern search circuit of the optical disc drive will be employed to search the data sync pattern in the head of the cluster K area. With the determination of the cluster K area, then a data demodulating and processing circuit in the optical disc drive will be started to demodulate and process the user data in the cluster K area to obtain demodulated data. A data decoder in the optical disc drive can decode the demodulated data to obtain the user data recorded in the cluster K area.

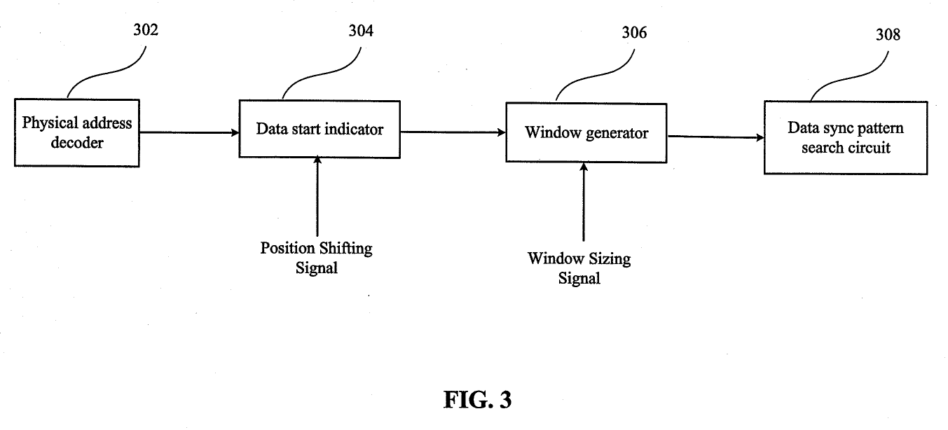

However, a data search system for searching a data sync pattern according to the present invention further decodes the physical address signal read from the physical address content to obtain a physical address of a current position where a pickup head indicates as a reference to search the data sync pattern in the head of the cluster K area. By determining the cluster K area with the exact position information of the data sync pattern, an excellent and accurate decoding result of the user data can be obtained. As a result, the objective of the present invention seeks to obtain a low failure rate of searching the data sync pattern that is significant to an optical disc drive. More detailed description of the functional block construction of the present invention will be presented later with reference to FIG. 3.

Please refer to FIG. 1B, an illustration showing the physical address content corresponding to a current cluster and a blank of a non-consecutively recorded data in a Blu-Ray R/RW optical disc. Some similarities as shown in FIG. 1A, the upper block line and the lower block line represent the physical address content and the data content respectively. However, as shown in FIG. 1B, the upper block line comprises a Sync3 block, a reference block and a 1st data block; the lower block line comprises a blank area, a Run-in area, a data sync pattern in the head of a cluster K area and the cluster K area of the data recorded in a Blu-Ray R/RW optical disc. It shows that the recording to the optical disc is started from the Run-in area and a blank area is prior to the Run-in area.

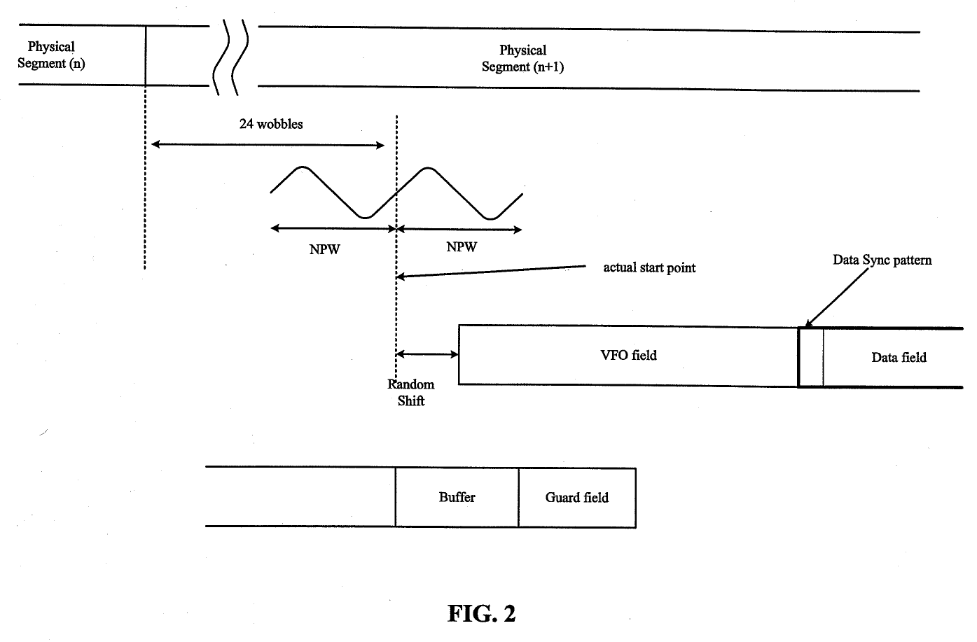

Please refer to FIG. 2, an illustration showing the physical segment content corresponding to a VFO field, a data sync pattern in the head of the data field, the data field, a buffer and a Guard field of a consecutively recorded data in a HD-DVD specification optical disc.

Although, the HD-DVD specification is not the same as the specification of the Blu-Ray R/RW optical disc, these specifications share similar definitions for the physical structures. Each of the physical segment (n) or physical segment (n+1) as shown in FIG. 2 corresponds to the physical segment content of the Blu-Ray R/RW optical disc.

The VFO field is similar to the Run-in area as shown in FIG. 1A and 1B. The data sync pattern is just like the data sync pattern of the Blu-Ray R/RW optical disc. The data field corresponds to the cluster K or cluster K-1 area used for recording the user data. The buffer is similar to the Run-out area. The Guard field is similar to the Guard_3 area. This is difference from the Blu-Ray R/RW optical disc that the start position of the VFO field should be 24 wobbles after the beginning of the physical segment (n) with a random shift similar as the 2.35 wobble shift allowance for the start position of the Run-in area in the Blu-Ray R/RW optical disc. The wobble is an NPW (Normal Phase Wobble), which can be modulated for storing data. The main concept of the present invention is to provide a data search system for searching a data sync pattern. Therefore, the data search system according to the present invention can be applied to either the Blu-Ray R/RW optical disc or the HD-DVD optical disc.

Please refer to FIG. 3 in conjunction with FIGS. 1A, 1B and FIG. 2. FIG. 3 illustrates a functional block diagram of a data search system for searching the data sync pattern by using a physical address according to first embodiment of the present invention. In the first embodiment, the data search system for searching the data sync pattern comprises a physical address decoder 302, a data start indicator 304, a window generator 306, and a data sync pattern search circuit 308. The physical address decoder 302 decodes a physical address signal read from the optical disc to obtain the physical address of a current position indicated by a pickup head of the optical disc drive. When the pickup head indicates a predetermined physical address, the data start indicator 304 generates a start search signal according to the predetermined physical address to decide a start position. The predetermined physical address can be a beginning position of the reference block or a beginning position of the first data block in physical address content of an optical disc. The window generator 306 receives the start search signal to generate a window interval starting from the start position. The data sync pattern search circuit 308 searches the data sync pattern of the data in the window interval to determine a cluster area of the data following the data sync pattern.

The predetermined physical address can be the beginning position of the reference block or the beginning position of the first data block in the physical address content shown in FIG. 1A. By knowing the physical address content corresponding to the data content, the data start indicator 304 detects a Run-in area defined prior to the data sync pattern to inform the optical disc drive being prepared to search for the coming predetermined physical address. When the pickup head indicates the predetermined physical address of a Blu-Ray disc, the data start indicator 304 generates the start search signal. In an HD-DVD disc, the data start indicator 304 detects a VFO field defined prior to the data sync pattern and generates the start search signal when the pickup head indicates the predetermined physical address. Although the Blu-Ray and HD-DVD discs are illustrated here but not a restriction to the present invention. The data search system for searching the data sync pattern according to the present invention also can be employed to the discs such as CD, DVD or other discs.

Furthermore, the data start indicator 304 further receives a position shifting signal from the optical disc drive for adjusting the start position. The window generator 306 further receives a window sizing signal from the optical disc drive for adjusting a size of the window interval for searching the data sync pattern of the data. The window interval is defined as a time period. Furthermore, the data sync pattern search circuit can generate a pseudo sync signal if the data sync pattern is not found in the window interval for the optical disc drive to encode the cluster area of the data and thereby preventing unstable status of the whole optical disc drive.

With such variable and flexible data searching system according to the present invention, a low failure rate of searching the data sync pattern for a non-consecutively recorded data or even a consecutively recorded data can be obtained more quickly and correctly.

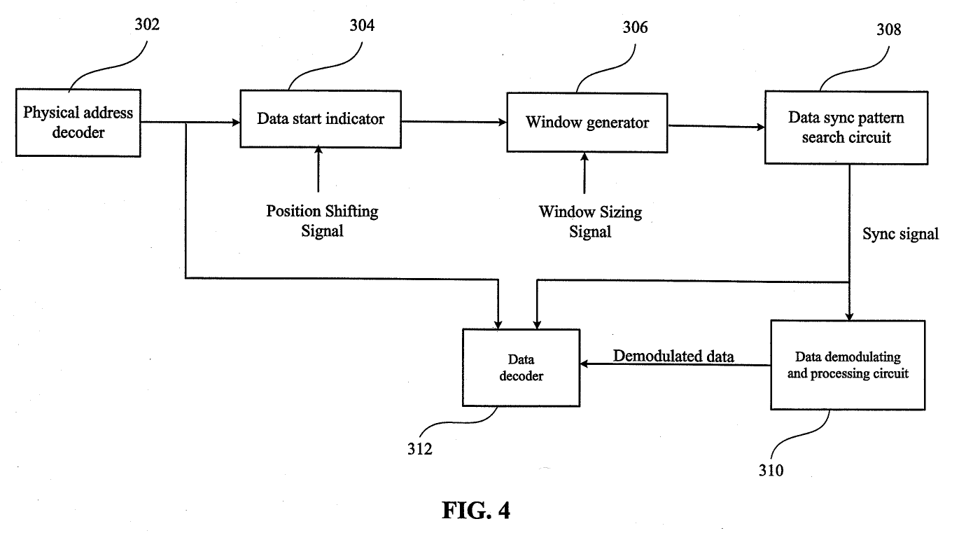

Please refer to FIG. 4, illustrating a functional block diagram of a data search system further comprising a data demodulating and processing circuit 310, and data decoder 312 according to second embodiment of the present invention. As the data sync pattern search circuit 308 searches and confirms the data sync pattern in the head of the cluster area of the data. The data sync pattern search circuit 308 will generate a sync signal for the data demodulating and processing circuit 310 as a trigger signal. The data demodulating and processing circuit 310 starts to demodulate and process the cluster area in order to obtain demodulated data after receiving the sync signal from the data sync pattern search circuit 308. And then, the data decoder 312 decodes the demodulated data to obtain the user data. Moreover, the data decoder 312 also receives the physical address of a current position from the physical address decoder 302 and transmits both to the optical disc drive.

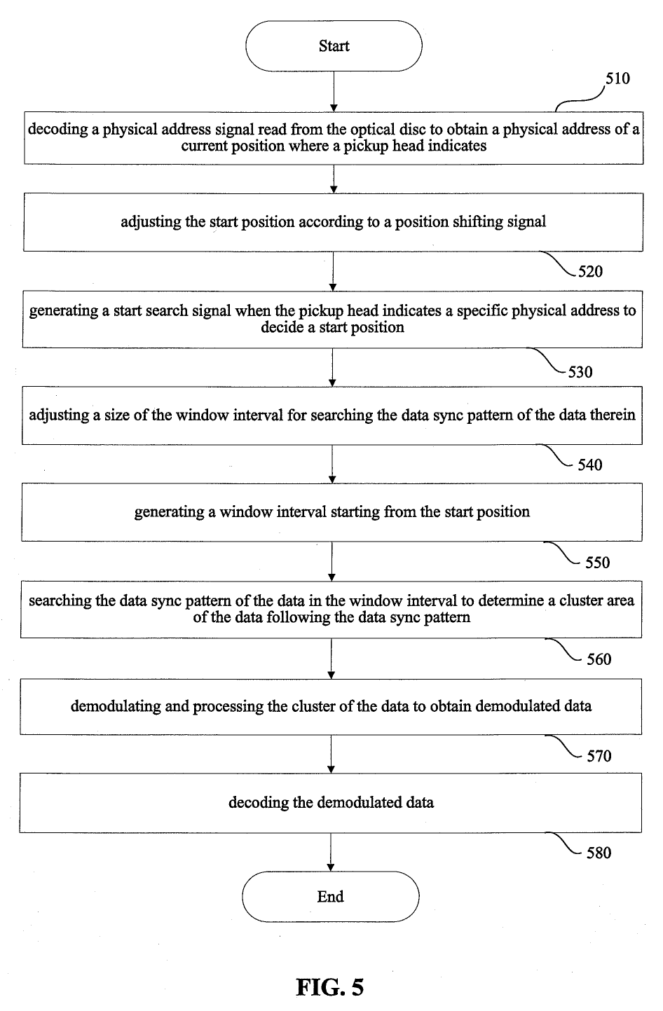

FIG. 5 shows a flow chart of the method of searching a data sync pattern stored in an optical disc according to the first embodiment of the present invention.

The method of searching a data sync pattern stored in an optical disc comprises the steps below:

In step 510, decoding a physical address signal read from the optical disc to obtain a physical address of a current position indicated by a pickup head;

In step 530, generating a start search signal indicating a predetermined physical address according to the obtained physical address to decide a start position;

In step 550, generating a window interval starting from the start position; and

In step 560, searching the data sync pattern of the data in the window interval to determine a cluster area of the data following the data sync pattern.

The method of searching the data sync pattern further comprises a step 520, adjusting the start position according to the position shifting signal before the step of generating the start search signal; step 540, adjusting the size of the window interval before the step of generating a window interval. The method of searching the data sync pattern further comprises a step 570, demodulating and processing the cluster area of the data to obtain demodulated data after the step 560; and step 580, decoding demodulated data to obtain the user data.

With reference to the physical address and the adjustable window interval and the adjustable start search position for the window interval, accordingly, a data search system for searching the data sync pattern by a physical address according to the present invention can obtain a low failure rate of searching the data sync pattern for a non-consecutively recorded data and even for a consecutively recorded data can be obtained more quickly and correctly.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

1. A data search system for searching a data sync pattern stored in an optical disc, the system comprising:
a physical address decoder, decoding a physical address signal read from the optical disc to obtain a physical address of a current position where a pickup head indicates;
a data start indicator, generating a start search signal when the pickup head indicates a predetermined physical address to decide a start position; and
a data sync pattern search circuit, searching the data sync pattern of the data from the start position.

2. The system of claim 1, further comprising a window generator, receiving the start search signal to generate a window interval starting from the start position for the data sync pattern search circuit to search the data sync pattern therein.

3. The system of claim 2, wherein the window generator further receives a window sizing signal for adjusting a size of the window interval for searching the data sync pattern of the data according to the window sizing signal.

4. The system of claim 2, wherein the size of the window interval is a time period.

5. The system of claim 1, wherein the data sync pattern search circuit searches the data sync pattern to determine a cluster area of the data following the data sync pattern.

6. The system of claim 1, wherein the data start indicator further receives a position shifting signal for adjusting the start position.

7. The system of claim 1, wherein the data start indicator detects a Run-in area defined prior to the data sync pattern and generates the start search signal when the pickup head indicates the predetermined physical address of a Blu-Ray disc.

8. The system of claim 1, wherein the data start indicator detects a VFO field defined prior to the data sync pattern and generates the start search signal when the pickup head indicates the predetermined physical address of a HD-DVD.

9. The system of claim 1, wherein the predetermined physical address is a beginning position of a reference block.

10. The system of claim 1, wherein the predetermined physical address is a beginning position of a first data block.

11. The system of claim 1, wherein the data sync pattern search circuit generates a pseudo sync signal if the data sync pattern is not found in the window interval.

12. The system of claim 1, further comprising a data demodulating and processing circuit and a data decoder, the data demodulating and processing circuit starting to demodulate and process the cluster of the data to obtain demodulated data according to the sync signal from the data sync pattern search circuit and the data decoder decoding the demodulated data.

13. The system of claim 12, wherein the decoder receives the physical address from the physical address decoder and the data search system searches a target data in the optical disc according to the physical address.

14. A method of searching a data sync pattern stored in an optical disc, the method comprising the steps of:
decoding a physical address signal read from the optical disc to obtain a physical address of a current position where a pickup head indicates;
generating a start search signal when the pickup head indicates a predetermined physical address to decide a start position; and
searching the data sync pattern of the data from the start position to determine a cluster area of the data following the data sync pattern.

15. The method of claim 14, further comprising a step of generating a window interval starting from the start position for the data sync pattern search circuit to search the data sync pattern.

16. The method of claim 15, further comprising a step of adjusting a size of the window interval for searching the data sync pattern of the data before the step of generating a window interval according to a window sizing signal.

17. The method of claim 14, further comprising a step of adjusting the start position according to a position shifting signal before the step of generating the start search signal.

18. The method of claim 14, further comprising steps of demodulating and processing the cluster of the data to obtain demodulated data after the step of searching the data sync pattern of the data and decoding the demodulated data after the step of demodulating and processing the cluster of the data.

19. The method of claim 18, further comprising a step of searching a target data in the optical disc according to the physical address after the step of decoding the demodulated data.

20-22. (canceled)
